(19) United States
(12) Patent Application Publication
(10) Pub. No.: US 2025/0127596 A1
(43) Pub. Date: Apr. 24, 2025

(54) Splint for treating tooth misalignments with a device for fastening the splint and production method thereof

(71) Applicant: Hans Peter Herrmann, Sindelfingen (DE)

(72) Inventor: Hans Peter Herrmann, Sindelfingen (DE)

(21) Appl. No.: 18/682,078

(22) PCT Filed: Jul. 28, 2022
(86) PCT No.: PCT/EP2022/071232

§ 371 Date: Feb. 7, 2024

(30) Foreign Application Priority Data
Aug. 25, 2021 (DE) DE102021004365.0

(51) Int. Cl. A61C 8/00; A61C 7/36

(52) U.S. Cl. CPC A61C 8/0096; A61C 7/36

(57) ABSTRACT

A processing method and apparatus for ultrafast laser deposition of a multilayer film including a diamond-like carbon film, an anti-reflection film and an anti-fingerprint film includes: generating primary plasma by first excitement on a target material with a femtosecond or picosecond pulsed laser beam as a pre-pulse; and generating secondary plasma by second excitement on the target material under plasma grating, formed by allowing two femtosecond pulsed laser beams to intersect at a small include angle for interaction in the primary plasma, for deposition to coat a film.

The present invention generally relates to the field of orthodontics and the reversible fastening of transparent orthodontic splints for correcting tooth misalignments. Such splints are generally referred to as aligners.

In particular, the present invention relates to a splint for treating tooth misalignments with a device for fastening the splint to temporary anchoring elements anchored in the jawbone and production method thereof.

Transparent splints for moving teeth have been developed since the late 1990s. These are usually splints made of plastic which can be placed over a dental arch. First of all, a mould of the patient's dental arches was made here so that a digital 3D model of the teeth could then be produced via a scan of the mould. Using this model, the desired alignment of the teeth can be set using interactive computer software. The software then suggests successive intermediate stages between the current and the desired alignment, and transparent plastic or acrylic aligners are created which the patient wears for a certain amount of time before moving on to the next stage. Each aligner exercises a small corrective force on the teeth through elastic deformation of the aligner body and thereby moves the teeth in the desired direction. The treatment can extend over a relatively long period of time since a series of successive aligners are used. When moving teeth with the aid of orthodontic splints (aligners), the aligners are generally anchored to the teeth. In some cases, what are referred to as attachments are applied to the teeth for this purpose.

A disadvantage with the known splint systems is that aligners are ineffective for certain tooth movements since the anchoring in the dental arch always also affects the teeth not involved in the movement. This often causes undesired movements and anchoring loss which require what is referred to as overcompensation in order to achieve the desired final position of the teeth.

To avoid reciprocal forces on the dental arch, the teeth that are to be moved can be supported in the bone by means of temporarily incorporated implants (TADS=temporary anchorage devices). A fastening device with bent metal wires or metal tubules and/or plates with holes is known for connecting the aligner to the temporary anchoring devices. Anchoring wires applied to the tubules are bent and firmly adhered to two teeth and the plates are screwed to the incorporated implants.

It is true that this known fastening means that the teeth that are to be moved are supported on the jawbone. However, the force acts primarily on the teeth to which the fastening device is adhered, so an equal force does not act on the whole of the dental arch. A further disadvantage is that the aligners which are then placed over this dental arch and parts of the adhered fastening device have play. The adhesive can also come unstuck. Furthermore, the fastening device located in the upper or lower jaw of the patient is often felt to be irritating, particularly as leftover food can get caught and entangled on the wires or plates of the fastening device.

A further disadvantage of the previously known fastening is that the manufacture of such individual fastening devices is associated with further costs and expense.

An orthopaedic apparatus for advancing the lower jaw with an elastic advancement web with two ends and an implanted screw device is known from US 2006/0172251A. Each end of the advancement web has a respective opening for anchoring to an implanted screw device. The ends of the advancement web are fastened to the implanted screw devices by a securing screw element being screwed through an opening in the connecting element connected to the respective end of the advancement web to the bone screw element implanted in the bone and as a result a part of the connecting element is firmly clamped between the screw elements. This splint acts in an intermaxillary manner.

US 2020/0383710 A teaches an upper jaw expander and a protraction device comprising a device to be anchored in the jawbone on its own or in combination with fixed or adjustable aligners.

The object of the present invention is to provide a splint that can easily be fastened into the temporary anchoring elements which can be anchored in the jawbone and enables effective tooth movement and simple cleaning of the oral cavity, and to indicate a production method.

This object is solved by the features of claims 1 and 10.

According to the invention, provision is made for a splint and a helical fastening device which can be fastened in the temporary anchoring element and has a head, wherein the splint is configured such that it has at least one cup-shaped recess or opening for receiving the head of the fastening device and the head of the fastening device is shaped in such a manner that it can be inserted into the cup-shaped recess or can be inserted through the opening in the splint so that the fastening device can be connected with a force fit and releasably to the splint.

Because the splint, according to the invention, is provided with at least one cup-shaped recess or opening and the recess is configured corresponding to the shape of the head of the fastening device so that the head can be inserted into the recesses or can be inserted through the openings, according to the invention, provision is made for a force-fitting connection which can easily be released by the patient themselves by pulling the head of the fastening device off or out of the recess or opening. The patient can therefore remove the splint indirectly fastened to the temporary implant for cleaning and then use it again themselves by pushing the recesses on or pushing the openings through the screw heads.

This enables simple and hygienic cleaning not only of the aligner, but also of the oral cavity, which is not the case with the previously known fastening devices with tubules, rods and plates remaining in the mouth.

A further advantage of the invention is the simple production of the splint according to the invention since, compared to the usual production of the splints, the moulding of the dental arch is carried out only with the already implanted temporary anchoring means with the fastening devices connected thereto, so that, in the production of the splints, the position of the already implanted temporary anchoring means with the fastening means fastened thereto can be taken into account. The cup-shaped recesses are usually produced by deep drawing.

The expensive production and adaptation of the previously known fastening systems can therefore be avoided.

The connection between the fastening device and the splint can be made by the head of the fastening device being configured to be knob-shaped, that is to say to be protruding, and by the splint having a recess and therefore being cup-shaped, which corresponds to the negative shape of the head of the fastening device, so that a force fitting connection is achieved if the head of the fastening device is inserted into the recess in the splint corresponding thereto. The splint therefore fully surrounds the head of the fastening device.

In a preferred variant, the splint is releasably connected to the fastening devices by a purely force fitting connection by a cylindrical head of the fastening device being inserted into a cylindrical recess in the splint similarly to the connection in a Lego® block. The diameters are matched to one another here so that the splint can be detached from the fastening devices if desired, but any unintentional release of the splint from the fastening devices when being used as intended is prevented.

In a further preferred variant, the head of the fastening device has an undercut so that the head of the fastening device is latchable or can be clamped in the cup-shaped recess corresponding thereto. In this variant, the fastening device may also be referred to as a clamping element. In this variant of the head with an undercut, the side wall of the head may, for example, taper like a truncated cone in the direction of the stem or have a concave or convex shape or an outwardly pointing edge level with the equator of the head. In this variant, there is therefore both a force fitting and, as a result of the undercut, a form fitting connection.

In principle, the head of the fastening device may be both round and angular, in particular having four or six corners, or be of some other shape.

The form and force fitting connection between fastening devices and splint is advantageously configured such that the splint can be removed from the fastening devices a number of times without causing any destruction owing to the elasticity of the splint material.

In order to enable the splint with the cup-shaped recesses to be able to be placed on more easily, the head of the fastening element can also be bevelled.

A cup-shaped recess, according to the invention, is understood to be any hollow body that is open on one side, the shape of the hollow body substantially corresponding to the shape of the head of the fastening device.

With the present invention, the effectiveness of orthodontic treatments in aligner therapies is improved since the splints, by means of the fastening devices connected to the splints with a force fit and preferably also a form fit, which are in turn screwed to the anchoring elements anchored in the bone, are indirectly anchored in the bone and as a result fewer damaging forces are applied to the rest of the teeth held in the splint, so fewer side effects occur.

The fastening device may consist of a mouth-resistant medical steel or of a hard plastic material approved for the oral cavity, such as PMMA, for example.

The splint is generally transparent and preferably an intramaxillary splint, in particular an aligner, that is to say a transparent splint made of plastic or acrylic for the application of forces for tooth movement in a jaw. The material of the splint should have a certain elasticity so that it can be placed over the heads.

Preferably, the splint is produced by vacuum or overpressure technology, by means of printing, in particular 3D printing, or by additive manufacture, in particular additive 3D printing.

The positions of the cup-shaped recesses of the splint or the openings depend on the position of the temporarily implanted anchoring elements.

In principle, it is sufficient to fasten the splint to a fastening device by means of a cup-shaped recess or an opening. Preferably, however, the fastening is carried out with two cup-shaped recesses or openings on two fastening devices. More than two fastening devices, in particular three or four, are also possible.

The invention also relates to a method for producing a splint with a fastening device, wherein the dental arch and palate area of the patient, including the fastening devices fastened to the implanted temporary anchoring elements, are moulded or captured by means of a scan, a 3D model is produced therefrom, the intermediate stage between the current and the desired alignment of the teeth is calculated therefrom and, on the basis of these data and the position of the fastening elements, one or more splints with cup-shaped recesses are produced from a transparent plastic material having a certain elasticity.

The invention is described by way of example hereinbelow by reference to exemplary embodiments, the invention not being limited to the features of the exemplary embodiments described. In the drawings,

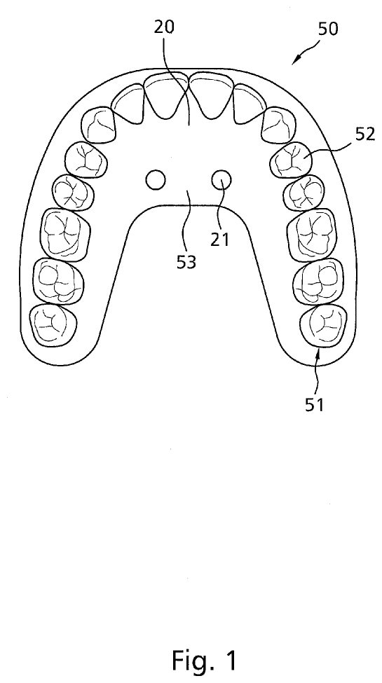

FIG. 1 shows the palate area with teeth and a splint with two cup-shaped recesses for receiving the fastening devices,

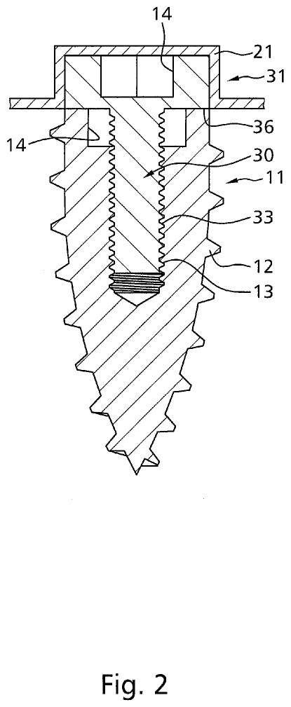

FIG. 2 shows a section through a fastening device 30 screwed in the temporary anchoring element, with a cylindrical head according to a first variant, wherein the head is received in a cylindrical recess of the splint,

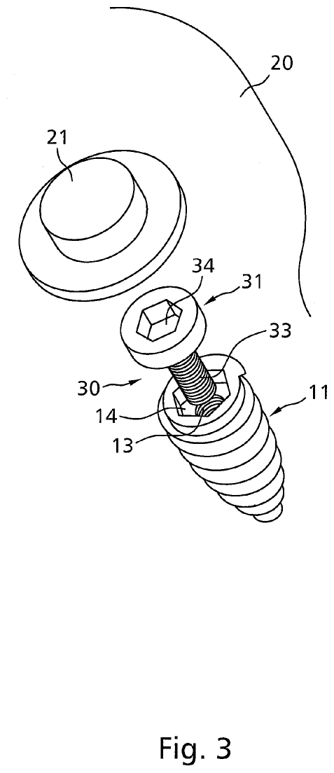

FIG. 3 shows the individual parts from FIG. 2 as an exploded view,

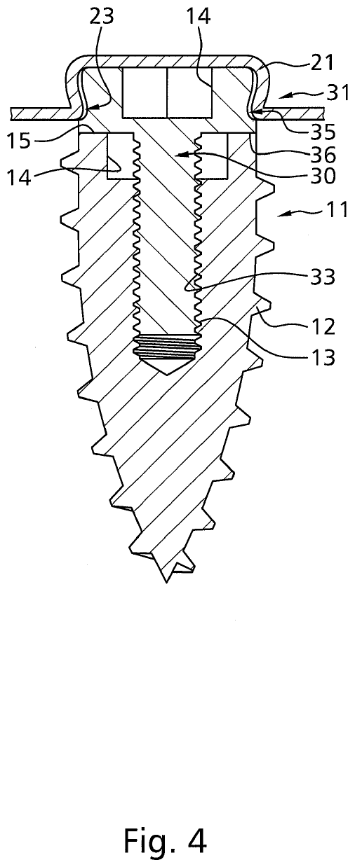

FIG. 4 shows a section through a fastening device screwed in the temporary anchoring element, with a head with an undercut according to a second variant, wherein the head can be received and latched or clamped in a corresponding recess in the splint,

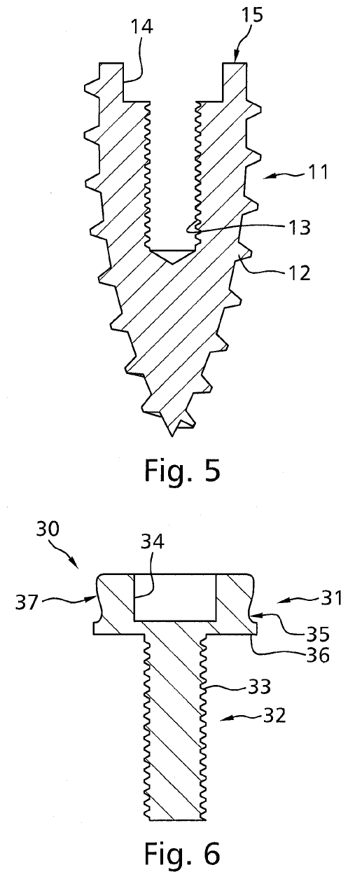

FIG. 5 shows a section through an anchoring element temporarily anchorable in the jaw (TADS implant),

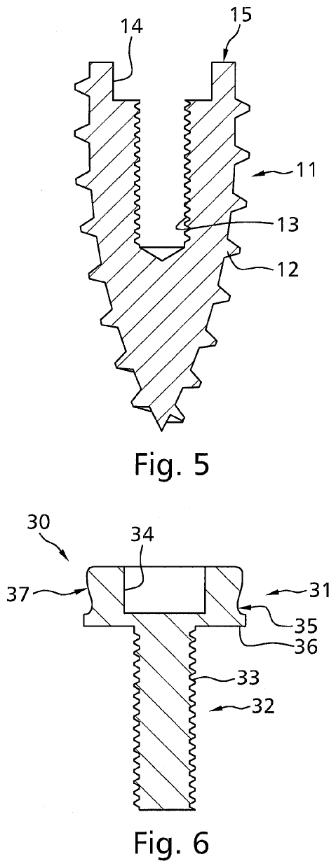

FIG. 6 shows a section through the helical fastening device,

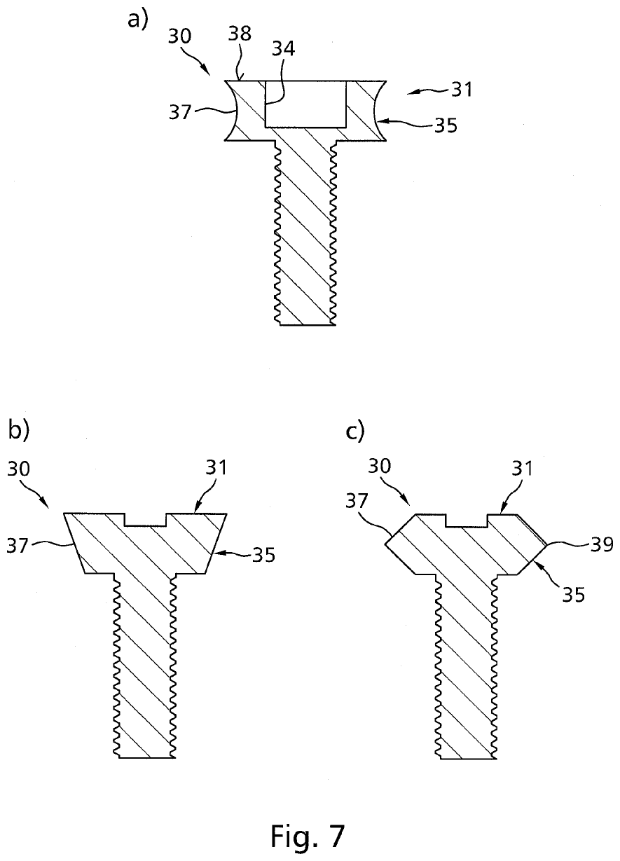

FIG. 7 shows different heads of the fastening device,

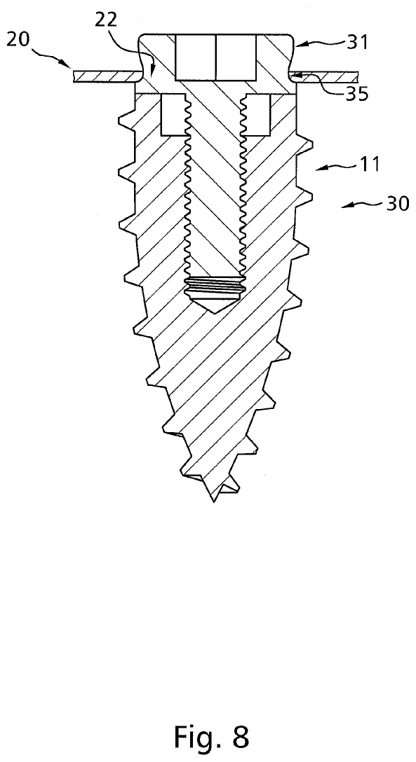

FIG. 8 shows a section similar to FIG. 4, but with the head of the fastening device inserted through an opening in the splint.

FIG. 1 schematically shows the view from above of the palate area 50 in the upper jaw with the dental arch 51 and the teeth 52. Placed over the dental arch 51 is a splint 20 which, in the present example, also covers part of the front palate area 53.

The splint 20 has two cup-shaped recesses 21 which may be located in the front palate area 53 in the upper jaw illustrated here. In a splint 20 for the lower jaw, the cup-shaped recesses 21 are generally arranged buccally or lingually.

The cup-shaped recesses 21 serve to receive the heads 31 of the helical fastening devices 30, as shown in FIGS. 2 to 4.

The connection between the screw head 31 and the cup-shaped recess 21 can only be made on the basis of a form fitting connection, as schematically illustrated in FIGS. 2 and 3 with the cylindrical screw head 31, or by means of a force fitting and form fitting connection, as shown in FIG. 4 in the case of the screw head 31 with an undercut 35 and the correspondingly shaped recess 21.

Apart from the different shape of the screw head 31 and of the recess 21 corresponding thereto, FIGS. 2 and 4 are identical.

The helical fastening device 30 is connected, preferably screwed, to the temporary anchoring elements 11 anchored in the jaw. However, the connection between temporary anchoring element 11 and fastening device 30 can also be made by means of adhering or clamping or some other way.

The temporary anchoring element 11 which is schematically illustrated in FIG. 5 is known per se and has on its outside a thread 12 by means of which it can be screwed into the jawbone. On the upwardly facing side, the anchoring element 11 has drive means 14, for example with a hexagonal profile 14, by means of which the anchoring element 11 can be screwed into the bone with a suitable spanner.

The fastening device 30 illustrated in FIG. 6 is helical, has a stem 32 with an external thread 33 and a screw head 31 and serves, on the one hand, for fastening in the temporary anchoring element 11 and, on the other, for releasably fastening to the splint 20. The fastening to the temporary anchoring element 11 is carried out by screwing the external thread 33 in the internal thread 13 of the anchoring element 11.

After screwing in, the underside 36 of the head 31 of the fastening device 30 lies on the upwardly facing side 15 of the anchoring element 11.

The shape of the screw head 31 may be different. On the one hand, the side wall 37 of the head 31 running perpendicularly to the front surface 30 according to FIG. 2 may be cylindrical so that it can be inserted into a likewise cylindrical recess in the splint 20 and is fixed there by a force fitting (static friction) connection.

After the fastening device 30 has been screwed firmly in the implanted temporary anchoring element 11, through the insertion of the cylindrical heads 31 of the fastening devices 30 into the cylindrical cup-shaped recesses 21 according to FIG. 2, a force fitting connection between splint 20 and fastening device 30 and therefore ultimately a connection between the splint 20 and the jawbone is therefore provided which is releasable by pulling the head 31 of the fastening device 30 out of the recess 21 of the splint 20.

However, the head 31 may also have an undercut 31, as illustrated in FIG. 4 and FIG. 7a-c, so that the head 31 can be latched or clamped in the corresponding recess 21. For this purpose, the recess 21 has a constriction 23 corresponding to the shape of the head 31.

The side wall 37 running perpendicularly to the front surfaces 38 of the screw head 31 may be concavely shaped (FIG. 7a), or taper like a truncated cone in the direction of the stem 32 (FIG. 7b) or have a convex shape or even have an outwardly pointing edge on the equator 39 of the head 31 (FIG. 7c). The heads 31 with an undercut can of course also be shaped differently.

By latching the head 31 with an undercut 35 in the cup-shaped recess 21, a force fitting and form fitting connection is achieved, cf. FIG. 4, and therefore any unintentional release of the splint as made even more difficult.

The splint 20 can easily be released from the fastening devices 30 in the implanted anchoring elements 11 by the patient themselves both in the case of a purely force fitting connection according to FIG. 2, and in the case of the latching connection according to FIG. 4 by the splint being pulled out.

In a further variant illustrated in FIG. 8, the head 31 of the fastening device 30 has an undercut 35 and the head 31 is latched with the splint 20, as described above in FIG. 4, but not by means of the cup-shaped recess 21 which corresponds to the shape of the head 31. Instead, the head 31 with the undercut 35 is inserted through an opening 22 in the splint 20. The shape of the opening 22 corresponds to the shape of the head 31 and is preferably circular. However, the opening may also be angular or differently shaped. This connection is secured against any unintentional release by the undercut 35.

This variant also enables an already existing splint 20 to be able to be fastened to the anchoring elements 11 by means of the fastening devices 30 in the manner according to the invention. If the position of the fastening devices 30 fastened in the implanted anchoring elements 11 is known, only the corresponding openings 22 have to be made in the splint 20 which have a diameter such that the heads of the fastening devices 30 can be inserted through the openings 22.

In this variant, the fastening devices 30 are not fully covered by the splint 20, but instead protrude through the openings 22 in the splint 20. The head 31 is circularly surrounded by the openings 22.

Conversely, in the above-described variant with the splint 20 with the cup-shaped recess 21, the cup-shaped recess 21, which is part of the splint and is moulded into the splint material during production, completely covers the fastening devices.

I claim:

1. An orthodontic aligner system, for treating tooth misalignments in a patient, the system comprising:
a. a helical shaped fastening device (30) for fastening a splint (20) to a temporary anchoring element (11), and, the temporary anchoring element can be anchored in the jawbone of the patient, and,
b. the fastening device (30) has a head (31) and a stem (32) and the stem is connectable to the temporary anchoring element (11) by means of a screw thread (33), and,
c. the splint (20) has at least one cup-shaped recess (21) or an opening (22) for receiving the head (31) of the fastening device (30), and,
d. the head (31) of the fastening device (30) is shaped in such a manner that it can be inserted into the cup-shaped recess (21) or can be inserted through the opening (22) in the splint (20) such that the fastening device (30) can be releasably connected with a force fit to the splint (20).

2. The system according to claim 1, wherein the head (31) of the fastening device (30) is latchable to the splint (20).

3. The system according to claim 2, wherein the head (31) of the fastening device (30) has an undercut (35).

4. The system according to claim 1, wherein the head (31) of the fastening device (30) has a side wall (37) and an equator (39), and, the sidewall is: a) cylindrical and circular or angular, in particular having four or six corners, or, b) tapers like a truncated cone in the direction of the stem (32), or, c) has a convex shape or an outwardly pointing edge on the equator (39) of the head (31).

5. The system according to claim 1, wherein the cup-shaped recesses in the splint have constrictions.

6. The system according to claim 1, wherein the splint is: a) transparent or b) an intramaxillary splint or c) made of transparent plastic or acrylic, for the application of forces for tooth movement in a jaw.

7. The system according to claim 1, the splint is produced by: a) vacuum or overpressure technology, or, b) by means of printing, in particular 3D printing, or, c) by additive manufacture, in particular additive 3D printing.

8. The system according to claim 1, wherein the fastening device is made of: a) a mouth-resistant medical steel, or, b) a hard plastic material approved for the oral cavity, in particular PMMA.

9. The system according to claim 1, wherein the splint comprises at least two cup-shaped recesses or at least two openings.

10. A Method for producing the system according to claim 1, wherein the dental arch and palate area of the patient, including the fastening devices fastened to the implanted temporary anchoring elements, are moulded or captured by means of a scan, a 3D model is produced therefrom, the intermediate stage between the current and the desired alignment of the teeth is calculated therefrom, and, on the basis of these data and the position of the fastening elements, one or more splints with cup-shaped recesses are produced from a transparent plastic material having a selected elasticity.
